(19) United States
(12) Patent Application Publication
(10) Pub. No.: US 2017/0347721 A1
(43) Pub. Date: Dec. 7, 2017

(54) CONDUCTIVE THREAD STITCHED STRETCH SENSOR

(71) Applicants: MARK GREENSPAN, Newark, DE (US); MARTHA HALL, Newark, DE (US); MICHELE LOBO, Newark, DE (US); HUANTIAN CAO, Newark, DE (US)

(72) Inventors: MARK GREENSPAN, Newark, DE (US); MARTHA HALL, Newark, DE (US); MICHELE LOBO, Newark, DE (US); HUANTIAN CAO, Newark, DE (US)

(73) Assignee: UNIVERSITY OF DELAWARE, Newark, DE (US)

(21) Appl. No.: 15/289,465

(22) Filed: Oct. 10, 2016

Related U.S. Application Data
(60) Provisional application No. 62/343,899, filed on Jun. 1, 2016.

(51) Int. Cl. A41D 1/00; G01B 7/16; D05B 97/08; G01L 1/22; D04B 1/14

(52) U.S. Cl. CPC A41D 1/005; G01L 1/2287; D04B 1/14; D05B 97/08; G01B 7/18

(57) ABSTRACT

Conductive thread stitched stretch sensors are described. The conductive thread stitched stretch sensors include a textile configured to stretch in at least one dimension and a conductive thread having a resistance between a first point and a second point stitched to the textile in a stitch geometry, the stitch geometry configured to stretch the conductive thread as the textile is stretched in the at least one dimension such that the resistance of the conductive thread increases between the first point and the second point due to elongation of the conductive thread as the textile is stretched. Also described are garments including conductive thread stitched stretch sensors and methods for making such sensors.

### CROSS REFERENCE TO RELATED APPLICATIONS

This application claims priority to U.S. Provisional application Ser. No. 62/343,899 entitled Conductive Thread Stitched Stretch Sensor filed on Jun. 1, 2016, the contents of which are incorporated fully herein by reference.

### STATEMENT REGARDING FEDERALLY SPONSORED RESEARCH

This invention was made with government support under contract number NIH 1R21HD076092-01A1 (PI: Lobo) awarded by the National Institutes of Health. The government has certain rights in this invention.

### BACKGROUND OF THE INVENTION

Measuring human movement for biomechanical analysis is currently measured using motion capture laboratory equipment. This equipment is the recognized standard within the health sciences, but has inherent limitations for practical application for some users including cost, specialized knowledge, and patient burden. Alternative methods, systems, and apparatus for measuring movement, especially in humans, that address these inherent limitations are desirable. Aspect of the invention address one or more of these needs among others.

### SUMMARY OF THE INVENTION

Aspects of the invention are embodied in conductive thread stitched stretch sensors. The conductive thread stitched stretch sensors include a textile configured to stretch in at least one dimension and a conductive thread having a resistance between a first point and a second point stitched to the textile in a stitch geometry, the stitch geometry configured to stretch the conductive thread as the textile is stretched in the at least one dimension such that the resistance of the conductive thread increases between the first point and the second point due to elongation of the conductive thread as the textile is stretched.

Aspects of the invention are also embodied in garments including conductive thread stitched stretch sensors and methods for making such sensors.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a letter designation referring to specific elements. When referring to the elements collectively or to a non-specific one or more of the elements, the letter designation may be dropped. This emphasizes that according to common practice, the various features of the drawings are not drawn to scale. On the contrary, the dimensions of the various features are arbitrarily expanded or reduced for clarity. Included in the drawings are the following figures:

FIG. 1A is a photograph of a representative conductive thread stitched stretch sensor in a relaxed state in accordance with aspects of the invention;

FIG. 1B is a photograph of the representative conductive thread stitched stretch sensor of FIG. 1A in a stretched state;

FIG. 2A is an conceptual illustration of a conductive thread for using in the conductive thread stitched stretch sensor of FIG. 1A;

FIG. 2B is a cross-sectional conceptual illustration of a conductive thread for using in the conductive thread stitched stretch sensor of FIG. 1A;

FIG. 3 is a computer generated image of a hypothetical user illustrating rotation/translation for measuring kinematics of the hypothetical user;

FIG. 4 is an illustration of a conductive thread in a relaxed state (top) and a stretched state (bottom) in accordance with aspects of the invention;

FIG. 5 is an illustration of a cross section of a conductive thread in a relaxed state (top) and a stretched state (bottom) in accordance with aspects of the invention;

FIG. 6 is an illustration of nine different stitches using the conductive thread in accordance with aspects of the invention; and

FIG. 7 is a flow chart illustrating a method for making a conductive thread stitched stretch sensor in accordance with aspects of the invention.

### DETAILED DESCRIPTION OF THE INVENTION

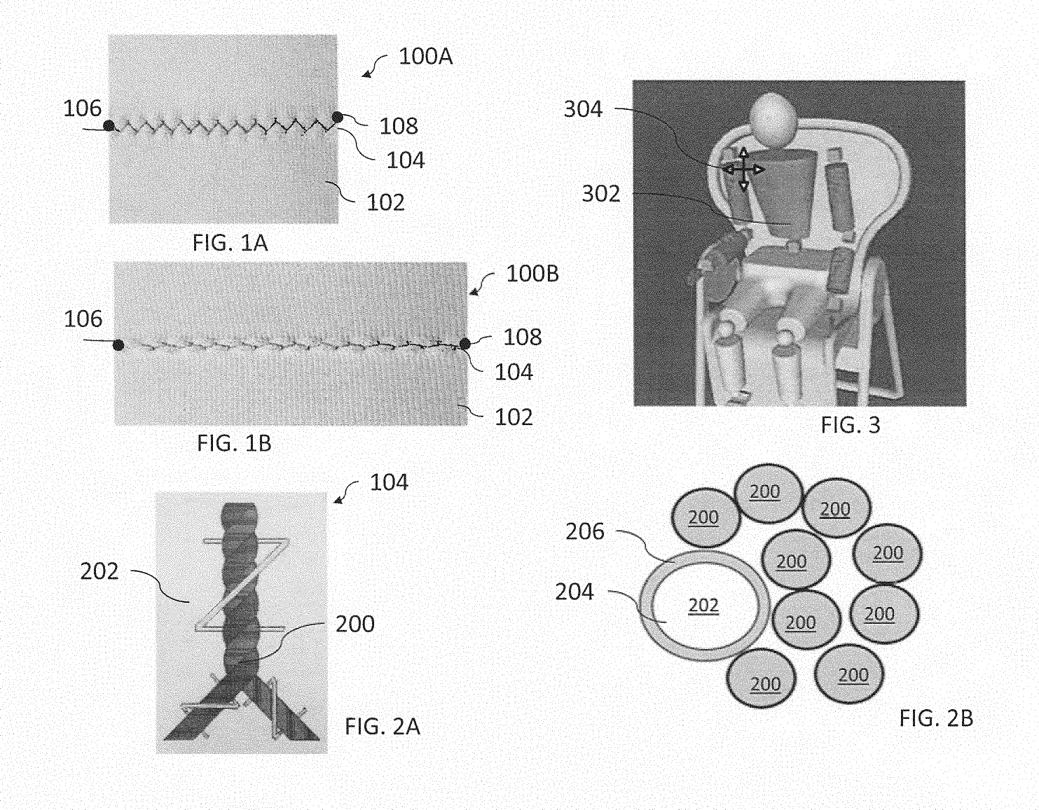

FIGS. 1A and 1B depicts a representative conductive thread stitched stretch sensor 100A/100B in an unstretched state 100A and a stretched state 100B in accordance with aspects of the invention. The sensor 100 includes a textile 102 and a conductive thread 104 stitched into the textile 102 in accordance with a stitch pattern.

The textile 102 is configured to stretch in at least one direction. A suitable textile for use at textile 102 is a knit material such as a synthetic knit material or a natural knit material. Other suitable textiles will be understood by one of skill in the art from the description herein. The textile 102 may be incorporated into a garment such as a shirt, a pair of pants, a compression sleeve, etc. or can be the garment itself. In an embodiment, the textile/garment is configured to stretch in a plurality of directions so as not to inhibit the movement of the wearer.

The conductive thread 104 is stitched into the textile 102 and is configured to change resistance as the textile is 102 and, in turn, the conductive thread 104 is stretched. The conductive thread is configured to exhibit an increase in resistance between a first point 106 and a second point 108 as it is stretched and a decrease in resistance as it contracts. A suitable conductive thread 104 is a Shieldex® Conductive Twisted Yarn Silver Plated Nulon 6 Yarn 22/1 dtex+113/32 dtex PET sold under part no. 261151022113 by VTT/Shieldex Trading USA of Palymyra, N.Y. Other suitable conductive threads will be understood by one of skill in the art from the description herein.

FIG. 2A conceptually depicts a conductive thread 104 in accordance with an aspect of the invention. The conductive thread 104 illustrated in FIG. 2A includes strands of polyethylene terephthalate (PET) 200 encircled by a strand of silver coated nylon 202. FIG. 2B conceptually depicts a cross section of the conductive thread 104 of FIG. 2A in accordance with an aspect of the invention. The conductive thread illustrated in FIG. 2B includes multiple strands of PET 200 and a single strand of silver coated nylon 202. The silver coated nylon includes a nylon core 204 coated with silver 206.

FIG. 3 depicts a hypothetical user 302 that would wear a garment/textile in accordance with aspects of the invention. Also depicted is rotation/translation 304 of a joint (shoulder in FIG. 3) that may be measured using conductive thread stitched stretch sensors in accordance with aspects of the invention. In an embodiment, a separate stitched stretch sensor is utilized for each translation and each rotation of each joint of interest.

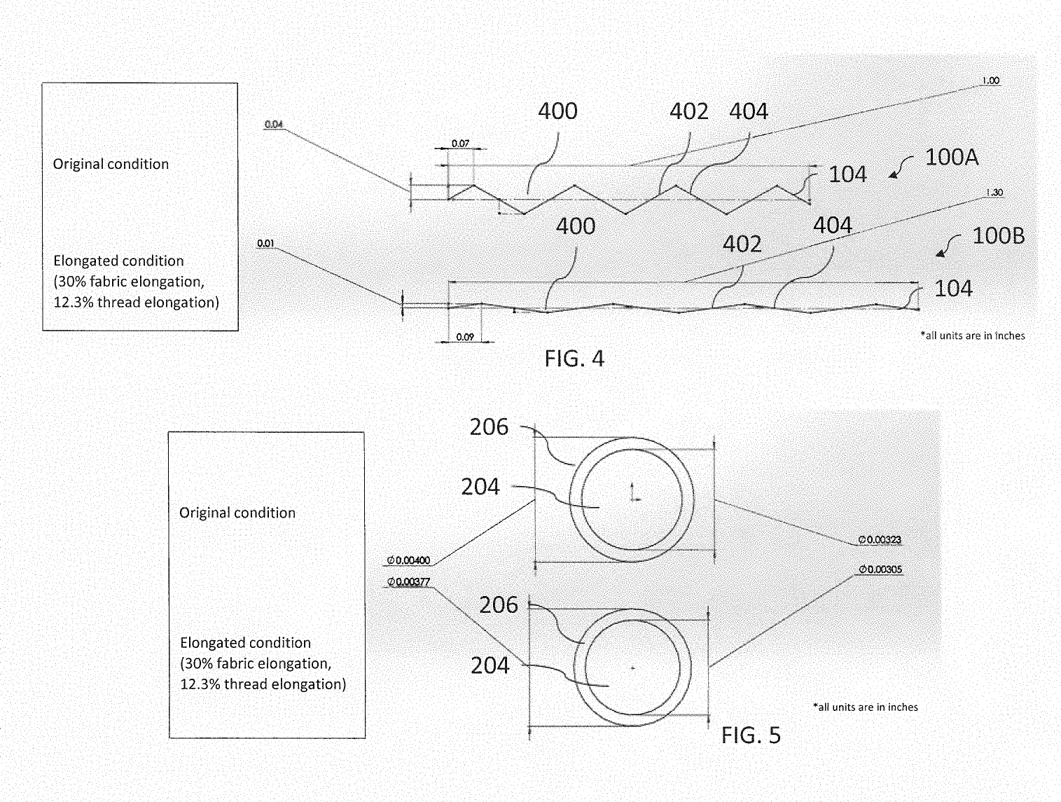

FIG. 4 depicts a stitch pattern for the conductive thread 104 in an un-stretched state (top) and stretched stated (bottom). The depicted stitch pattern is a saw tooth stitch pattern including multiple teeth. Each tooth of the pattern has a positive slope portion 402 and a negative slope portion 404 with respect to an axis 400. As the textile and, in turn, the conductive thread 104 is stretched, the positive slope portion 402 and, the negative slope portion 404 decrease in magnitude as illustrated in the bottom half of FIG. 4. In an embodiment, the saw tooth pattern is an American Society for Testing and Materials (ASTM) class 300 or 304 stitch (also known as a “zig-zag stitch”). As illustrated, contact between the teeth does not change from the unstretched state to the stretched state. Rather changes in resistance are due to a change in the resistance of the thread itself.

Although each tooth in the illustrated geometries are symmetrical, it is contemplated that one or more of the teeth may be asymmetrical with the positive slope portion having a different magnitude than the negative slope portion. For example, the positive slope portion may be essentially perpendicular and the negative slope portion may be 30 degrees or vice versa. Additionally, the slopes of the respective portions may change from tooth to tooth.

FIG. 5 depicts a cross section of the strand of silver coated nylon 202 of FIG. 2A in a un-stretched state (top) and stretched state (bottom). As the thread and, in turn, the silver coated nylon 202 is stretched, the cross sectional area of the silver coated 206 is reduced. The reduction is cross section area results in an increase in resistance between points on the conductive thread.

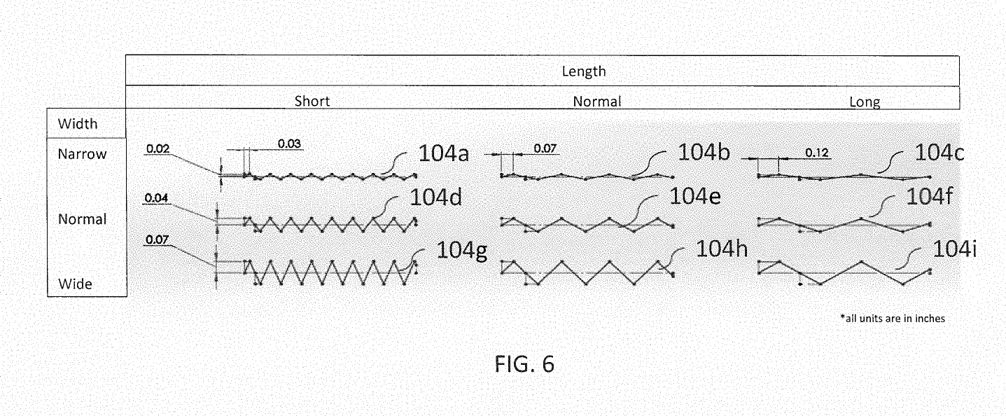

FIG. 6 depicts nine different stitched thread geometries in a related state in accordance with aspects of the invention. The particular geometry for a conductive thread stitched stretch sensor may be selected based on the particular joint and the particular rotation/translation to be measured using that sensor. For example, if the goal is to measure large change in resistance over a short elongation distance (˜2 inches, e.g., 1 inch or ¼ inch), a narrow width, long configuration geometry (upper right) would be the most appropriate. On the other hand, if the goal is to measure a change in resistance over a long elongation distance (˜6 inches and greater, e.g., 12 inches or 3 feet), then a wide width, short configuration geometry (lower left) could be used. In an embodiment, by way of non-limiting example, the tooth width is between 0.04 and 0.14 inches and the tooth length is between 0.06 and 0.24 inches. It will be understood that smaller/greater tooth widths and tooth lengths may be selected based on the joint being measured and its associated degree of rotation/translation.

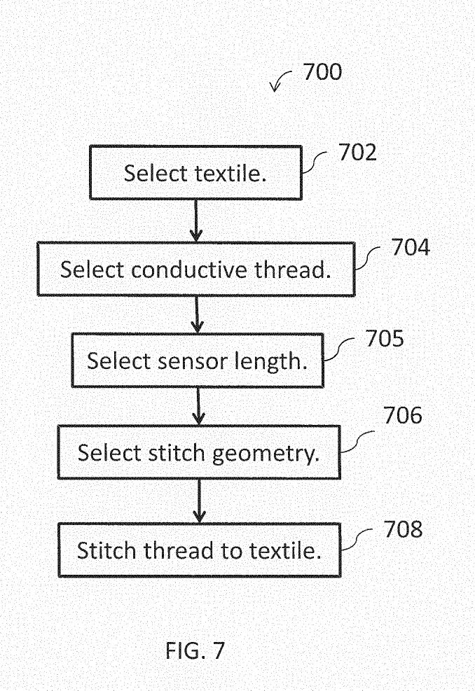

FIG. 7 depicts a method 700 for making a conductive thread stitched stretch sensor in accordance with aspects of the invention. It will be understood by one of skill in the art that one or more of the steps may be performed in an order other that depicted in FIG. 7.

As step 702, a textile is selected. The textile may be selected based on comfort for the wearer, elasticity, and durability.

At, step 704, a conductive thread is selected. The conductive thread may, be selected based on durability and resistance change rate when stretched.

At step 705, a sensor length is selected. The length of the sensor may be based on the joint being measured and the associated degree of rotation/translation as the length of the sensor will change as the joint is moved.

At step 706, a stitch geometry is selected based on the sensor length. The stitch geometry may be selected to provide the greatest change in resistance based on the particular joint, the associated rotation/translation being measured, and the sensor length taking into consideration that the stick geometry will change as the sensor stretches. For each joint there will be multiple rotations and/or translations and the magnitude of the rotations/translations may be different from one joint to the next. Thus, multiple geometries may be selected with each conductive thread stitched stretch sensor having a corresponding geometry unique to the rotation/translation it will be measuring.

At step 708, the conductive thread is stitched to the textile using the selected geometry. In an embodiment, the conductive thread is stitched to the textile using a sewing machine such as an industrial lockstitch machine, an industrial zigzag machine, or a domestic sewing machine. Other suitable methods for stitching the thread to the textile will be understood by one of skill in the art from the description herein.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A conductive thread stitched stretch sensor comprising:
a textile configured to stretch in at least one dimension; and
a conductive thread having a resistance between a first point and a second point stitched to the textile in a stitch geometry, the stitch geometry configured to stretch the conductive thread as the textile is stretched in the at least one dimension such that the resistance of the conductive thread increases between the first point and the second point due to elongation of the conductive thread as the textile is stretched.

2. The sensor of claim 1, wherein the textile has a relaxed state in which the textile is not stretched in the at least one dimension and a stretched state in which the textile is stretched in the at least one dimension and wherein the stitch geometry is a saw tooth geometry in which contact between adjacent teeth of the saw tooth geometry does not change when the textile transitions from the relaxed state to the stretched state.

3. The sensor of claim 2, wherein the saw tooth geometry has a tooth width between 0.04 and 0.14 inches and a tooth length between 0.06 and 0.24 inches.

4. The sensor of claim 2, wherein a distance between the first point and the second point along a surface of the textile is between ¼ inch and 3 feet when the textile is in the relaxed state.

5. The sensor of claim 1, wherein the conductive thread is silver-coated conductive thread.

6. The sensor of claim 5, wherein the silver-coated conductive thread has a cross-sectional area that decreases as the silver-coated thread is stretched such that the resistance between the first point and the second point increases as the silver-coated thread is stretched.

7. The sensor of claim 1, wherein the textile is a knit material.

8. A garment comprising:
at least one textile, each textile configured to stretch in at least one dimension; and
at least one conductive thread, each conductive thread having a resistance between a first point and a second point stitched to an associated one of the at least one textile in a stitch geometry, the stitch geometry configured to stretch the conductive thread as the associated textile is stretched in the at least one dimension such that the resistance of the conductive thread increases between the first point and the second point due to elongation of the conductive thread as the textile is stretched.

9. The garment of claim 8, wherein the garment is configured to measure kinematics of a user wherein the at least one conductive thread includes at least one conductive thread for each rotation or translation of a corresponding movement of the user being measured.

10. The garment of claim 8, wherein the textile has a relaxed state in which the textile is not stretched in the at least one dimension and a stretched state in which the textile is stretched the at least one, wherein the stitch geometry is a saw tooth geometry in which contact between adjacent teeth of the saw tooth geometry does not change when the textile transitions from the relaxed state to the stretched state.

11. The garment of claim 10, wherein the saw tooth geometry, has a tooth width between 0.04 and 0.14 inches and a tooth length between 0.06 and 0.24 inches.

12. The garment of claim 10, wherein a distance between the first point and the second point along a surface of the textile is between ¼ inch and 3 feet when the textile is in the relaxed state.

13. The garment of claim 8, wherein the conductive thread is silver-coated conductive thread.

14. The garment of claim 13, wherein the silver-coated conductive thread has a cross-sectional area that decreases as the silver-coated thread is stretched such that the resistance between the first point and the second point increases as the silver-coated thread is stretched.

15. The garment of claim 8, wherein the textile is a knit material.

16. A method for making a conductive thread stitched stretch sensor comprising:
selecting a textile configured to stretch in at least one dimension;
selecting a conductive thread having a resistance between a first point and a second point;
selecting a length;
selecting a stitch geometry based on the length;
stitching the conductive thread to the textile in accordance with the stitch geometry, the stitch geometry configured to stretch the conductive thread as the textile is stretched in the at least one dimension such that the resistance of the conductive thread increases between the first point and the second point due to elongation of the conductive thread as the textile is stretched.

17. The method of claim 16, wherein the textile has a relaxed state in which the textile is not stretched in the at least one dimension and a stretched state in which the textile is stretched in the at least one dimension and wherein the stitch geometry is a saw tooth geometry in which contact between adjacent teeth of the saw tooth geometry does not change when the textile transitions from the relaxed state to the stretched state.
